(19) United States
(12) Patent Application Publication
(10) Pub. No.: US 2007/0048120 A1
(43) Pub. Date: Mar. 1, 2007

(54) Vacuum shroud for a die attach tool

(75) Inventors: Nicholas Paul Costen, Greenbelt, MD (US); Sally Jonina Merritt, Austin, TX (US)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED

(21) Appl. No.: 11/203,894

(22) Filed: Aug. 15, 2005

(51) Int. Cl. B65G 1/133

(52) U.S. Cl. 414/749.1

(57) ABSTRACT

According to one embodiment of the invention, a system for die attach includes a wafer disposed outwardly from a carrier tape, the wafer having a plurality of die associated therewith, a pick head operable to, via a vacuum, pick up a die to be processed, and a shroud surrounding the pick head. A vacuum exhaust may be coupled to a sidewall of the shroud to redirect air leakage within the shroud generated by a bond force pressure chamber away from a top surface of the die to be processed and out of the shroud.

### TECHNICAL FIELD OF THE INVENTION

This invention relates generally to the fields of both integrated circuit packaging and microelectromechanical system (“MEMS”) packaging and, more specifically, to a vacuum shroud for a die attach tool.

### BACKGROUND OF THE INVENTION

Die attach tools are utilized to pick die from a pre-cut wafer and place them on a substrate. Typically, the semiconductor die are protected by, for example, a passivation oxide to protect them from the environment. MEMS die, however, are normally not sealed until fully packaged. Generally, a “pick head” of the die attach tool uses air from a pressurized chamber to apply the appropriate bond force after picking the die off the wafer carrier tape. Generating this pressure may cause some leakage of air and associated particles down the pick head shaft and die. For any die that are not protected by a passivation oxide or the like, this can result in unwanted particles from embedding in or otherwise (mechanically, optically, etc.) interfering with the die in such a manner that the die is unusable, which significantly hurts yield.

### SUMMARY OF THE INVENTION

According to one embodiment of the invention, a system for die attach includes a wafer disposed outwardly from a carrier tape, the wafer having a plurality of die associated therewith, a pick head operable to, via a vacuum, pick up a die to be processed, and a shroud surrounding the pick head. A vacuum exhaust may be coupled to a sidewall of the shroud to redirect air leakage within the shroud generated by a bond force pressure chamber away from a top surface of the die to be processed and out of the shroud.

Some embodiments of the invention provide numerous technical advantages. Other embodiments may realize some, none, or all of these advantages. For example, embodiments of the invention include a vacuum shroud that surrounds a pick head of a die attach tool in order to keep detrimental particles away from the die being picked and placed, as well as adjacent die on the wafer, which improves yield. The vacuum shroud is especially advantageous for clean room die attach tools and/or unprotected die and is designed such that it does not interfere with the 3D movements of the rotary pick head.

Other technical advantages are readily apparent to one skilled in the art from the following figures, descriptions, and claims.

### BRIEF DESCRIPTION OF THE DRAWINGS

For a more complete understanding of the invention, and for further features and advantages, reference is now made to the following description, taken in conjunction with the accompanying drawings, in which:

FIG. 1 is a schematic of a system for a die attach tool according to one embodiment of the invention.

### DETAILED DESCRIPTION OF EXAMPLE EMBODIMENTS OF THE INVENTION

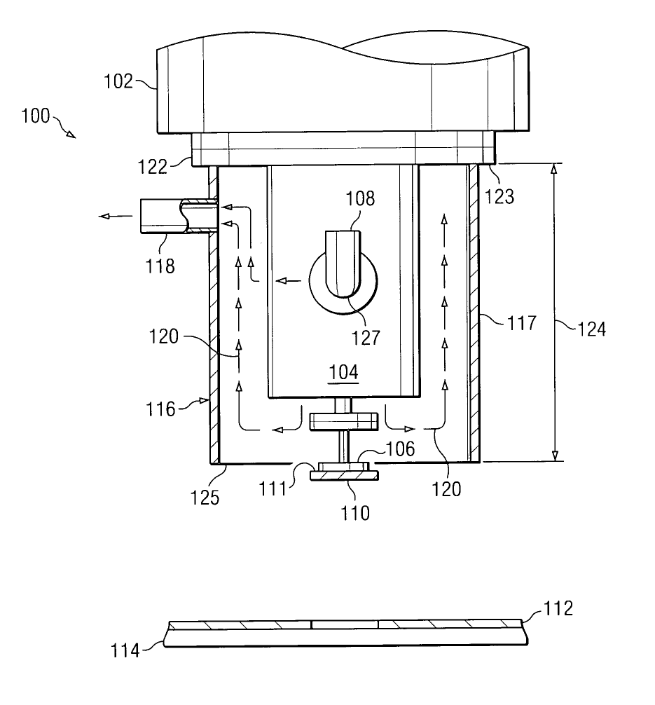

Example embodiments of the present invention and their advantages are best understood by referring now to FIG. 1, in which like numerals refer to like parts.

FIG. 1 is a schematic of a system 100 for a die attach tool 102 according to one embodiment of the invention. The present invention contemplates system 100 being utilized for any suitable die attach tool; however, in one particular embodiment of the invention, system 100 is used with the rotary die pick head unit of the ESEC Micron 2 die attach tool.

In the illustrated embodiment, die attach tool 102 includes a pick head 104 that is operable to pick up a die 110 by a vacuum force generated by a suitable vacuum source (not explicitly illustrated) that is coupled to a vacuum fitting 108. Pick head 104 may have any suitable size and shape and the vacuum source may generate any suitable vacuum force. A suitable controller (not explicitly illustrated) is operable to control the general operation of die attach tool 102, including but not limited to the movement of pick head 104.

Die 110 may be any suitable semiconductor or MEMS die formed from any suitable materials and is associated with a wafer 112 typically disposed outwardly from a carrier tape 114. Although the present invention contemplates system 100 being utilized with any suitable semiconductor or MEMS die, the present invention is particularly suitable for die that are unprotected, such as die that have no passivation oxide or other suitable protective layer or hermetic packaging associated therewith. For example, die 110 may be a portion of a digital micro-mirror device (“DMD”) or other suitable microelectromechanical system (“MEMS”) that is being fabricated in a suitable clean room.

As described in greater detail below, generation of bond force pressure may cause some leakage of air and concomitant particles around pick head 104 as well as die 110 and wafer 112. For die that are not protected by a passivation oxide or the like, this may result in unwanted particles in the air from embedding in or otherwise interfering (e.g., mechanically, optically) with these die in such a manner that these die are unusable, thereby significantly hurting yield.

Thus, according to the teachings of the present invention, system 100 includes a shroud 116 surrounding pick head 104, an vacuum exhaust 118 coupled to a sidewall 117 of shroud 116, and a base 122. Shroud 116 may have any suitable size and shape and may be formed from any suitable material. Preferably, shroud 116 does not interfere with the movement of pick head 104 and is formed from a material that is non-particle generating material. In one embodiment of the invention, shroud 116 is cylindrical and is formed from aluminum. The cylindrical nature of shroud 116 is thought to control turbulence of air within shroud 116 better than other shapes contemplated for shroud 116. Shroud 116 may have any suitable length 124; however, in one embodiment, length 124 is sufficient to allow an end 125 of shroud 116 to extend no further than the top of a collet 106 when die 110 is being processed. For example, if system 100 is utilized with the rotary die pick head unit of the ESEC Micron 2 die attach tool, then length 124 may be approximately 36 millimeters.

Shroud 116 may be coupled to base 122 in any suitable manner. Base 122 is configured to allow shroud 116 to be coupled to die attach tool 102 in any suitable manner. For example, base 122 may have one or more bolt holes 123 associated therewith to allow shroud 116 to be fastened to die attach tool with suitable bolts. Base 122 may have any suitable size and shape and may also be formed from any suitable material, such as a non-particle generating material.

Vacuum exhaust 118 may be any suitable conduit coupled to a vacuum or other suitable suction source that is operable to alter the air flow within shroud 116. In one embodiment, vacuum exhaust 118 is operable to redirect air leakage from a bond force pressure chamber (not explicitly illustrated) at the die vacuum interface 127 out of shroud 116, as indicated by the general direction of arrows 120. Vacuum exhaust 118 changes or otherwise controls the turbulence of air within shroud 116 caused by the bond force leakage in order to keep unwanted particles in the air away from a top surface 111 of die 110 and wafer 112 so that die 110 and wafer 112 do not get contaminated with the unwanted particles. Vacuum exhaust 118 is coupled to sidewall 117 in any suitable location and orientation that minimizes particulate turbulence. For example, vacuum exhaust 118 may be perpendicular, tangential, or otherwise suitably positioned within sidewall 117. In addition, vacuum exhaust 118 is preferably located such that vacuum exhaust 118 is above die 110 when die 110 is being processed. Any suitable vacuum or suction force is contemplated by the present invention depending on the operating parameters of die attach tool 102 or the expected turbulence within vacuum shroud 116. In addition, there may be more than one vacuum exhaust 118 associated with shroud 116.

In operation of one embodiment of the invention, wafer 112 is disposed outwardly from carrier tape 114 and has a plurality of die 110 associated therewith. Wafer 112 is disposed underneath system 100 that is coupled to die attach tool 102 by base 122. The bond force pressure chamber supplies the air that allows pick head 104 to extend downwardly in order to pick up die 110 with the help of vacuum source 108. Once a vacuum source 108 is activated, pick head 104 is retracted upwardly and die 110 is disengaged from a portion of carrier tape 114. Since some die vacuum air leakage 127 occurs within shroud 116, vacuum exhaust 118 redirects the air (as indicated by arrows 120) away from top surface 111 of die 110 and out of shroud 116 via a suitable vacuum exhaust line. Pick head 104 may then be directed by the controller of die attach tool 102 to a different location where die 110 is then coupled to a suitable substrate.

Thus, system 100 having shroud 116 that surrounds pick head 104 of die attach tool 102 minimizes detrimental particles from embedding in or otherwise interfering with die 110 or other die on wafer 112. This is done by controlling the turbulence of air surrounding pick head 104, redirecting it away from surface 111 of die 110 and then out of shroud 116 through vacuum exhaust 118. As described above, system 100 is particularly suitable for die attach tools used in clean rooms that are used to process unprotected die, and shroud 116 may be designed such that it does not interfere with any three-dimensional movements of die attach tool 102.

Although embodiments of the invention and their advantages are described in detail, a person skilled in the art could make various alterations, additions, and omissions without departing from the spirit and scope of the present invention, as defined by the appended claims.

What is claimed is:

1. A system for die attach, comprising:
a wafer disposed outwardly from a carrier tape, the wafer having a plurality of die associated therewith;
a pick head operable to, via a vacuum, pick up a die to be processed; and
a shroud surrounding the pick head.

2. The system of claim 1, wherein the shroud comprises a cylindrical shroud.

3. The system of claim 1, further comprising a vacuum exhaust coupled to a sidewall of the shroud and operable to redirect air leakage from a bond force pressure chamber within the shroud.

4. The system of claim 3, wherein the vacuum exhaust is located such that the vacuum exhaust is above the die to be processed.

5. The system of claim 1, further comprising a vacuum exhaust coupled to a sidewall of the shroud and operable to redirect air leakage from a bond force pressure chamber within the shroud away from a top surface of the die to be processed and out of the shroud.

6. The system of claim 1, wherein the pick head is associated with a rotary die attach tool.

7. The system of claim 6, further comprising a base configured to couple the shroud to the rotary die attach tool.

8. The system of claim 1, further comprising a collet coupled to the pick head and wherein the shroud comprises a length sufficient to extend no further than a top of the collet when the die is being processed.

9. The system of claim 1, wherein the shroud is formed from aluminum.

10. A method of die attach, comprising:
providing a wafer having a plurality of die associated therewith;
picking up a die to be processed with a pick head via a vacuum;
surrounding the pick head with a shroud; and
redirecting air leakage generated from a bond force pressure chamber within the shroud.

11. The method of claim 10, wherein redirecting air leakage within the shroud comprises redirecting air leakage within the shroud away from a top surface of the die to be processed.

12. The method of claim 10, wherein redirecting air leakage within the shroud comprises redirecting air leakage within the shroud out through a vacuum exhaust coupled to a sidewall of the shroud.

13. The method of claim 12, wherein the vacuum exhaust is located such that the vacuum exhaust is above the die to be processed.

14. The method of claim 10, wherein the pick head is associated with a rotary die attach tool.

15. The method of claim 14, further comprising coupling the shroud to the rotary die attach tool.

16. The method of claim 10, further comprising causing the shroud to have a length sufficient to extend no further than a top of a collet associated with the pick head when the die is being processed.

17. A system for die attach in a clean room, comprising:
a die attach tool having a pick head;
a wafer disposed below the pick head, the wafer having a plurality of die associated therewith;
the pick head operable to, via a vacuum, pick up a die to be processed;
a cylindrical shroud coupled to the die attach tool and surrounding the pick head;
a vacuum exhaust coupled to a sidewall of the cylindrical shroud and operable to redirect air leakage generated from a bond force pressure chamber within the shroud away from a top surface of the die to be processed and out of the shroud; and
wherein the vacuum exhaust is positioned above the die to be processed.

18. The system of claim 17, wherein the die to be processed is a portion of a digital micro-mirror device.

19. The system of claim 17, wherein the die to be processed is a portion of an unprotected die.

20. The system of claim 17, wherein the cylindrical shroud is formed from aluminum.
